(19) United States
(12) Patent Application Publication
(10) Pub. No.: US 2018/0045204 A1
(43) Pub. Date: Feb. 15, 2018

(54) CEILING POT FAN

(71) Applicant: Bobby Mitchell Van Grootheest, Telkwa (CA)

(72) Inventor: Bobby Mitchell Van Grootheest, Telkwa (CA)

(21) Appl. No.: 15/237,282

(22) Filed: Aug. 15, 2016

(51) Int. Cl. F04D 25/08; F24F 7/007; F21V 33/00; F04D 29/40

(52) U.S. Cl. CPC F04D 25/088; F04D 29/403; F24F 7/007; F21V 33/0096

(57) ABSTRACT

An apparatus for ventilating a room comprises an outer casing having an open bottom and having a central axis extending therethrough and a fan coaxially supported within the outer casing along the central axis, the fan having a plurality of fan blades extending radially from the central axis. The apparatus further comprises an air opening extending into the outer casing around the fan and a ring surrounding the fan and separating the fan from the air opening and defining an air passage from the air opening to the fan.

### BACKGROUND OF THE INVENTION

### 1. Field of Invention

The present invention relates generally to ceiling fans and in particular to a ceiling fan and light combination which may be installed within a common housing above the ceiling without additional ductwork.

### 2. Description of Related Art

In the residential housing industry, ceiling mounted ventilation fans are available in a variety of configurations. However, in such uses ventilation ducts are not commonly installed within the ceiling cavity to discharge the ventilation air, and therefore drop down ceiling fans are typically installed to improve air circulation within a room. These devices may have other functions, as well, including integral illumination. Drop down ceiling fans may not be aesthetically pleasing to all users and intrude into the room, taking space.

Alternate ceiling air circulation systems which enclose the fan within a housing in the ceiling have been developed. These devices, however, require the units to be connected to an air duct to provide the air supply for the fan. Examples of such devices are US Patent Nos. 2010/0136897 A1 to Lee et al., 2013/0196588 A1 to Liao and 2013/008/4793 A1 to Yang.

### SUMMARY OF THE INVENTION

According to a first embodiment of the present invention there is disclosed an apparatus for ventilating a room comprising an outer casing having an open bottom and having a central axis extending therethrough and a fan coaxially supported within the outer casing along the central axis, the fan having a plurality of fan blades extending radially from the central axis. The apparatus further comprises an air opening extending into the outer casing around the fan and a ring surrounding the fan and separating the fan from the air opening and defining an air passage from the air opening to the fan.

The outer casing may be substantially cylindrical about the central axis. The apparatus may further comprise an inner housing wherein the air passage is defined between the inner housing and the ring. The inner housing may have a substantially semi-toroidal shape. The inner housing may extend from a bottom edge of the outer casing. The inner housing may include an annular wall extending upwardly towards a top of the outer casing sized to receive the fan motor therein.

The ring may include an outwardly radially lip extending therefrom. The lip may extend over a portion of the air opening. The lip may be spaced apart from a bottom of the outer casing. The ring includes a light source on a bottom surface thereof.

The fan may be supported and rotated by a fan motor supported within the outer casing. The apparatus may further comprise a light suspended from the fan motor within the plurality of fan blades. The fan may be adapted to have a reversible airflow therethrough.

The apparatus may further comprise an outer housing adapted to surround the outer casing. The outer housing may be adapted to be secured to a building above the ceiling.

According to a further embodiment of the present invention there is disclosed a method for forming ventilator for a room comprising the steps of locating an outer casing above a ceiling in the room having an opening extending through the ceiling and positioning a fan within the outer casing so to be coaxial with the opening therearound in the casing. The method further comprises rotating the fan as to draw air in through one of the opening and the fan and discharge the air through the other of the opening or the fan passing through an air passage between the outer casing and a ring located coaxially between the fan and the opening.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective cut-away view of an apparatus for ventilating a room and housing installed between two ceiling joists.

FIG. 2 is a bottom plan view of the apparatus of FIG. 1.

FIG. 3 is a cross-sectional view of the apparatus of FIG. 1 taken along the line 3-3.

### DETAILED DESCRIPTION

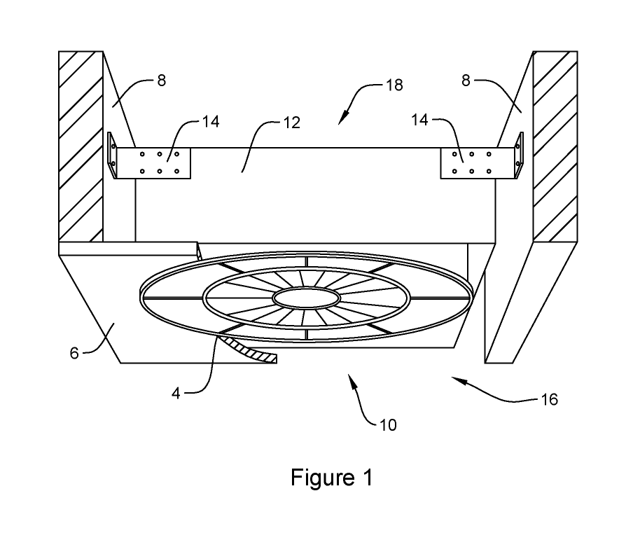

Referring to FIG. 1, an apparatus for ventilating a room according to a first embodiment of the invention is shown generally at 10. The apparatus 10 is mounted within a housing 12. The housing 12 is generally in the shape of a square box and includes mounting brackets 14, which may be attached to the housing 12 as well as to adjacent joists 8 above a ceiling 6, using any known means of attachment, such as, by way of non-limiting example, screws, nails, adhesives or the like. The housing 12 extends between bottom and top edges 16 and 18, respectively. The bottom edge 16 is open and communicates with the inside of a room through a ceiling opening 4 formed in the ceiling 6.

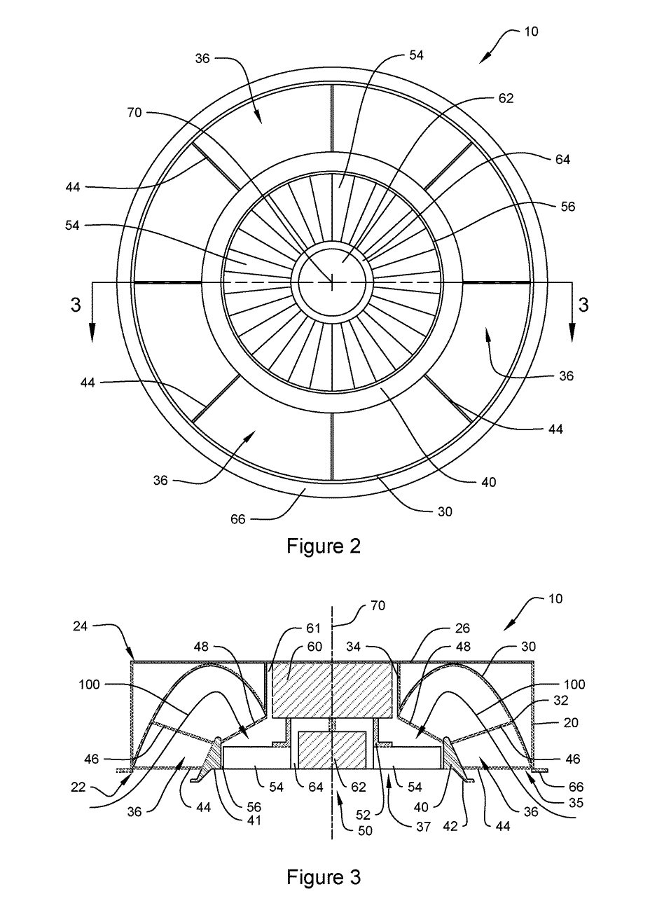

Turning now to FIGS. 2 and 3, the apparatus 10 is illustrated without the housing 12. FIG. 2 illustrates a bottom plan view of the apparatus 10, whereas FIG. 3 illustrates a cross-sectional view of the apparatus 10 taken along the line 3-3. The apparatus 10 comprises a cylindrical casing 20, extending between bottom and top edges 22 and 24, respectively, with a circular top plate 26 proximate to the top edge 24, with a common central axis 70. An inner air chamber housing 30 and an air director ring 40 are positioned within the cylindrical casing 20 defining an air passage 36 therebetween. The air passage 36 extends between a first end 35 proximate to the cylindrical casing 20 and a second end 35 proximate to the axis 70. Axially aligned within the housing 12 and cylindrical casing 20 is an illuminated fan unit 50, as will be more fully described below.

The cylindrical casing 20 may be sized to fit within the housing 12. In particular, the cylindrical casing 20 and housing 12 have a height between the top and bottom edges 24 and 22 sufficient to contain the air passage and fan unit 50. By way of non-limiting example, a height of between 4 and 12 inches (102 and 305 mm) may be used, although it may be appreciated that other heights may be useful, as well. The outer diameter of the cylindrical casing 20 may be selected to correspond to the opening 4 size, or be based upon the air circulation demands in the room, such as, by way of non-limiting example, between 12 and 48 inches (305 and 1220 mm). Optionally the cylindrical casing 20 and housing 12 may be sized to fit between a standard 24 inch (610 mm) joist span, although larger or smaller diameters may be useful, as well, to fit between alternate custom joist spans. The cylindrical casing 20 may have a plurality of bore holes (not shown) through the side to accommodate mounting screws or clips for securing within the housing 12 according to known means. The circular top plate 26 is substantially the same diameter as the cylindrical casing 20 and may be attached by any known means to the top edge 24 of the cylindrical casing 20. The top plate 26 may include a plurality of bore holes (not shown) to accommodate, such as, by way of non-limiting example, an electrical supply and mounting screws or clips, as are commonly known.

The inner air chamber housing 30 is comprised of a toroidal portion 32 and a cylindrical portion 34. The toroidal portion is generally formed in a toroidal shape, split essentially on the horizontal axis, with the bottom of the toroidal portion 32 open proximate to the bottom edge 22, forming a top surface to the air passage 36. The external diameter of the toroidal portion 32 is sized to fit within the cylindrical casing 20. The height of the inner air chamber housing 30 is sized to fit within the height of the cylindrical casing 20. The cylindrical portion 34 extends upward from the inner edge of the toroidal portion 32 to the top edge 24. The diameter of the cylindrical portion 34 is sized to receive an electric motor 60 therein. As illustrated in FIG. 3, an annular gap 61 surrounds the motor 60 to allow for airflow and heat dissipation around the motor 60, although it will be appreciated that for some motor selections the annular gap 61 may be eliminated. The inner air chamber housing 30 is attached to the cylindrical casing 20 by any known means, such as, by way of non-limiting example, fasteners, adhesives, welding or the like. It may be appreciated that the inner air chamber housing 30 may be omitted, allowing the air to pass through the cylindrical casing 20.

The air director ring 40 is formed in an annular shape, and is sized such that the cross sectional opening width at the second end 37 to the air passage 36 is essentially the same as the length of a fan blade 54. An annularly extending air deflector lip 42, as seen in FIG. 3, may optionally be formed on the air director ring 40 to improve room air circulation through the apparatus 10. A plurality of brackets 44, 46 and 48 are attached by any known means to support the air director ring 40 within the inner air chamber housing 30. Each set of brackets 44, 46 and 48 may be aligned, as best seen in FIG. 3, but it may be appreciated that other configurations may be useful, as well. FIG. 2 illustrates the present embodiment of the invention with 8 sets of brackets 44, 46 and 48, evenly distributed around the circumference of the inner air chamber housing 30, but it may be appreciated that more or less brackets may be useful, as well. It may be appreciated that in the case where the inner air chamber housing 30 may be omitted, the brackets 44, 46 and 48 may be attached to the cylindrical casing 20. An LED light strip may optionally be attached to an annular bottom surface 41 of the air director ring 40. It will also be appreciated that a grate of any known style may be located across the air passage 36 so as to provide an aesthetically pleasing covering for the air chamber 30.

The fan unit 50 is comprised of an electric motor 60, an illumination source 62, a plurality of fan arms 52 supporting a plurality of fan blades 54 therefrom. The motor 60 may be of any conventional type, as are commonly known. The illumination source 62 may be an LED or any other suitable light, and may be operably connected electrically and physically to the motor to be supported therefrom and not rotated with the fan blades in any means, as is commonly known. It may be appreciated that other illumination sources may be useful, as well. The plurality of fan arms 52 are attached to the rotator of the motor 60 and support the plurality of fan blades 54 therefrom as is commonly known. The fan blades 54 are selected to be of a commonly known design and style. An annular gap 64 of not less than ¼ inch (6.35 mm) separates the illumination source 62 and the inner edge of the fan blades 54. Similarly, an annular gap 56 of not less than ¼ inch (6.35 mm) separates the outer edge of the fan blades 54 and the air director ring 40.

To install the apparatus 10, the housing 12 is attached to the joists 8 during the construction phase, prior to installation of the ceiling 6. This is similar to the method used to install recessed lights during construction. Following installation of the ceiling 6, a circular ceiling opening 4 is cut in the ceiling 6 centred below the housing 12 to fit the cylindrical casing 20 with the fan unit 50, air deflector ring 40 and inner air chamber housing 30 therein. The cylindrical casing 20 is attached to the housing 12 and electric motor 60 and illumination source 62 are connected to the building electrical supply as is commonly known. An annular trim ring 66 is sized to cover the outer edge of the apparatus 10, and may be attached to the ceiling 6 using such as, by way of non-limiting example, screws, or it may be attached to the apparatus 10 using such as, by way of non-limiting example, clips or springs or may optionally be permanently connected to or co-formed with cylindrical casing 20. The annular trim ring 66 surrounds the outer edge of the apparatus 10 and serves to cover a lower periphery and inner circumferential surface of the ceiling opening 4 so as to prevent the ceiling opening 4 from being directly viewed from within the room.

When in use, the fan arms and attached blades 52 and 54 are rotated by the motor 60, when activated by a user. As best seen in FIG. 3, the room air is drawn through the ceiling opening 4 to the air passage 36 through the first end 35 thereof in the inner air chamber housing 30 in the general direction 100, and expelling from the apparatus 10 through the second end 37 downwards past the fan blades 54. Alternately, the motor may be reversed, and the air may be drawn upwards past the fan blades 54, through the air passage 36 into the inner air chamber housing 30 with the airflow in the opposite direction to that shown. When the illumination source 62 is turned on, the light is introduced to the room through the ceiling opening 4. It will be appreciated that the fan and lights may be operated in common or independently.

While specific embodiments of the invention have been described and illustrated, such embodiments should be considered illustrative of the invention only and not as limiting the invention as construed in accordance with the accompanying claims.

What is claimed is:

1. An apparatus for ventilating a room comprising:
an outer casing having an open bottom and having a central axis extending therethrough;
a fan coaxially supported within said outer casing along said central axis, said fan having a plurality of fan blades extending radially from said central axis;
an air opening extending into said outer casing around said fan; and
a ring surrounding said fan and separating said fan from said air opening and defining an air passage from said air opening to said fan.

2. The apparatus of claim 1 wherein said outer casing is substantially cylindrical about said central axis.

3. The apparatus of claim 1 further comprising an inner housing wherein said air passage is defined between said inner housing and said ring.

4. The apparatus of claim 3 wherein said inner housing has a substantially semi-toroidal shape.

5. The apparatus of claim 4 wherein said inner housing extends from a bottom edge of said outer casing.

6. The apparatus of claim 5 wherein said inner housing includes an annular wall extending upwardly towards a top of said outer casing sized to receive said fan motor therein.

7. The apparatus of claim 1 wherein said ring includes an outwardly radially lip extending therefrom

8. The apparatus of claim 7 wherein said lip extends over a portion of said air opening.

9. The apparatus of claim 8 wherein said lip is spaced apart from a bottom of said outer casing.

10. The apparatus of claim 1 wherein said ring includes a light source on a bottom surface thereof.

11. The apparatus of claim 1 wherein said fan is supported and rotated by a fan motor supported within said outer casing.

12. The apparatus of claim 11 further comprising a light suspended from said fan motor within said plurality of fan blades.

13. The apparatus of claim 11 wherein said fan is adapted to have a reversible airflow therethrough.

14. The apparatus of claim 1 further comprising an outer housing adapted to surround said outer casing.

15. The apparatus of claim 14 wherein said outer housing is adapted to be secured to a building above the ceiling.

16. A method for forming ventilator for a room comprising the steps of:
locating an outer casing above a ceiling in the room having an opening extending through said ceiling;
positioning a fan within the outer casing so to be coaxial with said opening therearound in said casing; and
rotating said fan as to draw air in through one of said opening and said fan and discharge said air through said other of said opening or said fan passing through an air passage between said outer casing and a ring located coaxially between said fan and said opening.
